(19) United States
(12) Patent Application Publication
(10) Pub. No.: US 2010/0056397 A1
(43) Pub. Date: Mar. 4, 2010

(54) Method of Producing Microarray Having Immobilized Double-Stranded Nucleic Acid Probe Including Double-Stranded Region and Single-Stranded Region

(76) Inventor: Joo-Won Rhee, Yongin-si (KR)

Correspondence Address: F. CHAU & ASSOCIATES, LLC, 130 WOODBURY ROAD, WOODBURY, NY, 11797, US

(21) Appl. No.: 12/548,843

(22) Filed: Aug. 27, 2009

(30) Foreign Application Priority Data
Aug. 27, 2008 (KR) 10-2008-0084041

(51) Int. Cl. C40B 50/18

(52) U.S. Cl. 506/32

(57) ABSTRACT

A method of producing a microarray having an immobilized double-stranded nucleic acid probe including a double-stranded region and a single-stranded region includes immobilizing nucleic acids by synthesizing nucleic acids by using photolithography and hybridizing nucleic acids. A microarray with a high spot density and with immobilized long probes may be prepared.

### CROSS-REFERENCE TO RELATED APPLICATIONS

This application claims the benefit of Korean Patent Application No. 10-2008-0084041, filed on Aug. 27, 2008, in the Korean Intellectual Property Office, the contents of which are herein incorporated by reference in their entirety.

### BACKGROUND

1. Technical Field

Embodiments of the invention are directed to a method of producing a microarray having an immobilized double-stranded nucleic acid probe including a double-stranded region and a single-stranded region.

2. Description of the Related Art

Methods of producing a nucleic acid array by using a photolithography method, also known as a light-directed synthesis process, are well known. These methods involve activating a predefined region of a substrate and then contacting the substrate with a preselected monomer solution. The predefined region may be activated by a light source, typically through a mask. The remainder of the substrate is blocked from the light source by the mask and chemically protected, thus being inert. Thus, it may be determined which region of the substrate is reacted with a monomer according to which region of the substrate is irradiated with a pattern of light. The activation of predefined region and the contacting of the substrate with another monomer solution are repeatedly performed to form a variety of nucleic acid arrays on the substrate. Other processes, including washing an unreacted monomer solution from the substrate, may be performed, if necessary.

An example of the methods of producing a nucleic acid array by using a light-directed synthesis method will now be described in greater detail. A surface of a solid support, which is selectively modified with a spacer having a photolabile protecting group, such as 6-nitroveratryloxycarbonyl (NVOC) or methyl-6-nitropiperonyloxycarbonyl (MeNPOC), is illuminated through a photolithographic mask, thereby exposing a reactive group (generally a hydroxyl group) in the illuminated region. A 3′-O-phosphoramidite-activated deoxynucleoside protected at the 5′-hydroxyl with a photolabile group is then presented to the surface of the solid support and chemical coupling occurs at sites exposed to light. Following capping and oxidation, the solid support is rinsed and the surface of the solid support is illuminated through a second mask, to expose additional hydroxyl groups for coupling. A second 5′-protected, 3′-O-phosphoramidite-activated deoxynucleoside is presented to the surface of the solid support. The selective photodeprotection and coupling cycles are repeated until the desired set of nucleic acids is obtained. Another example of the light-directed synthesis method discloses that photolabile protecting groups and photolithography are used to achieve light-directed spatially-addressable parallel chemical synthesis of an array of nucleic acids. In this method, computer tools may be used to help the formation of the array.

In such a light-directed synthesis of an array of nucleic acids, a plurality of nucleic acid probes may be synthesized in parallel in spatially-addressable predefined regions. Since the predefined regions are defined by light, the array of nucleic acids may be synthesized by narrowing an interval between the predefined regions, that is, increasing the density of predetermined regions. However, this method includes preparing a new mask for every cycle of a substrate, and thus there is a limitation on the length of nucleic acids that may be synthesized in terms of synthesis efficiency. Synthesis of nucleic acids with a length of 25 nt or less is commercially known.

In addition, a method of producing an array of nucleic acids by using a spotting method is known. In the spotting method, a reactant, such as previously synthesized nucleic acids or a nucleic acid monomer, is transferred to a selected region on a substrate such that a relatively small amount of the reactant is directly deposited on the selected region. The deposition may be performed by moving between the selected regions using a dispenser. Examples of dispensers include micropipettes for transferring a monomer solution to a substrate and robot systems for controlling a position of the micropipette with respect to a substrate, or inkjet printers. In addition, the dispenser may be a series of tubes, manifolds, and an array of pipettes, which allow a variety of reagents to be simultaneously transferred to reaction regions. In this method, foreign synthesized nucleic acids are immobilized on a substrate, and thus relatively long nucleic acids may be immobilized on the substrate. However, the immobilization is performed by direct deposition, and the spot density is low.

### SUMMARY OF THE INVENTION

Exemplary embodiments of the invention include a method of efficiently producing a microarray with a high spot density and with a long probe immobilized thereon.

Additional aspects will be set forth in part in the description which follows and, in part, will be apparent from the description, or may be learned by practice of the presented embodiments.

Exemplary embodiments of the invention may include a method of producing a microarray having an immobilized double-stranded nucleic acid probe including a double-stranded region and a single-stranded region, the method including: synthesizing nucleic acids on a plurality of spot regions on a surface of a solid substrate by using photolithography to immobilize a plurality of first single-stranded nucleic acids on the plurality of spot regions; and hybridizing each of the plurality of first single-stranded nucleic acids with a second single-stranded nucleic acid including a first region complementary to the plurality of first single-stranded nucleic acids and a second region that is not complementary to the plurality of first single-stranded nucleic acids to convert the plurality of first single-stranded nucleic acids to double-stranded nucleic acid probes including a double-stranded region and a single-stranded region, wherein the second region is positioned upstream from the first region when a 5′ terminal of the first single-stranded nucleic acid is attached to the surface of the substrate, and the second region is positioned downstream from the first region when a 3′ terminal of the first single-stranded nucleic acid is attached to the surface of the substrate.

### BRIEF DESCRIPTION OF THE DRAWINGS

FIGS. 1A and 1B are diagrams illustrating a method of producing a single-stranded microarray in a method of producing a microarray having an immobilized double-stranded nucleic acid probe, according to embodiments of the invention.

FIG. 2 is a diagram illustrating a method of converting the single-stranded microarray prepared in FIG. 1 to a double-stranded microarray.

### DETAILED DESCRIPTION OF EXEMPLARY EMBODIMENTS

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

A method according to an embodiment of the invention of producing a microarray having an immobilized double-stranded nucleic acid probe including a double-stranded region and a single-stranded region includes (a) synthesizing nucleic acids on a plurality of spot regions on a surface of a solid substrate by using photolithography to immobilize a plurality of first single-stranded nucleic acids on the spot regions.

The term “photolithography” includes selectively exposing a photosensitive surface to a light beam to form a pattern of light exposed areas and light nonexposed areas on the surface and reacting a molecule with the light exposed area to couple the molecule to the light exposed area. The photosensitive surface may include a chemically reactive group protected by a photoremovable group, and when the photosensitive surface is exposed to a light, the surface may be become reactive due to the removal of the photoremovable group. The reactant molecule may include an activated nucleoside, an activated nucleotide, an activated oligonucleotide or an activated polynucleotide protected with a photoremovable group at 3′ hydroxyl or 5′ hydroxyl group. Selectively exposing a photosensitive surface to a light beam may be conducted by placing a physical photomask in the path of light used for photoactivation. It may also be conducted without using a physical photomask, for examples by using a maskless photolithography system. The maskless photolithography systems is known to one of ordinary skill in the art and may include a system using an off-axis light source coupled with a digital micromirror array.

The operation of “synthesizing nucleic acids on the substrate by using photolithography” means that only certain regions on the substrate are irradiated by light, thereby introducing or producing an active reaction group on only the certain regions on the substrate, and the active reaction group is reacted with an activated molecules such as, nucleic acid monomer, oligomer or polymer, to extend a nucleotide of a nucleic acid on the substrate. It may include synthesizing a single stranded polynucleotide by extending one nucleotide by one nucleotide on the substrate. Light-directed synthesis methods of nucleic acids on a substrate are well known in the art. For example, these methods are disclosed in U.S. Pat. Nos. 5,143,854, 5,744,305, and 5,908,926, the disclosures of which are herein incorporated by reference in their entireties. The double-stranded region of the double-stranded nucleic acid probe is positioned on the surface of a substrate, that is, proximal to the surface of a substrate, and the single-stranded region thereof is positioned distal from the surface of a substrate. The double-stranded region may include the first single stranded nucleic acid and the second single-stranded nucleic acid, and the single-stranded region may include only the second single-stranded nucleic acid. The second single-stranded nucleic acids may include two regions that is, the region that forms a double stranded nucleic acid by hybridizing with the first single-stranded nucleic acid and the region that does not take part in the hybridization with the first single-stranded nucleic acid and thus, may remain as a single stranded form. The double-stranded nucleic acid probe may be a partial double stranded nucleic acid wherein the double stranded region is proximal to the substrate and the single stranded region is distal from the substrate. The single stranded region of the double-stranded nucleic acid probe may hybridize with a target nucleic acid having a complementary sequence, and thus acting as a probe.

In the operation of “synthesizing nucleic acids on the substrate by using photolithography,” a plurality of other nucleic acid sequences may be simultaneously synthesized in parallel on a plurality of predefined regions (hereinafter, referred to as “spots”) on a substrate.

The term “spot” used herein refers to a certain region on a surface, which is activated, previously activated, or desired to be activated for formation of a polymer, that is, a “predefined region.” The spot may have a convenient shape, for example, a circular, tetragonal, oval, or wedge-like shape.

The term “substrate” used herein refers to a material with a solid or semi-solid surface. Although a surface of a substrate may be substantially flat, at least a portion of a surface of a substrate may be physically isolated as a synthesis region with respect to other nucleic acids synthesis regions by a well, a heightened region, or an etched trench, etc.

The “light” used herein may be gamma-rays, X-rays, ultraviolet rays, visible rays, or infrared rays, and may be appropriately selected according to the type of a photoremovable protecting group used.

The operation (a) includes selectively irradiating a surface of a substrate with light through a patterned mask, selectively activating certain regions on the surface of the substrate, and reacting the activated regions with nucleic acid monomers, thereby extending nucleotides on the surface of the substrate. The selective activation of the certain regions on the surface of the substrate may be performed by light irradiation, when an active group is protected by a photoremovable protecting group on the surface of the substrate. In addition, the activation process may be performed by a chemical material for removing the photoremovable protecting group.

The operation (a) may include irradiating with light through a mask the surface of the substrate to which the photoremovable protecting group is attached to selectively remove the protecting group from the surface, thereby to form a pattern of reactive regions and light protected regions, and reacting the surface of the reactive regions with activated nucleic acid monomers having the photoremovable protecting group, thereby extending the nucleic acid monomers to the reactive regions on the substrate. The photoremovable protecting group may be removed from a surface of an irradiated region, which is irradiated by light, and thus the active reaction group is exposed. Thus, the surface of the irradiated region may be reacted with the activated nucleic acid monomer with the photoremovable protecting group. The nucleic acid monomer may be nucleosides or nucleotides.

The photoremovable protecting group attached to the surface of the substrate may be attached to the substrate through a linker. The linker may have an active group at a terminal of the linker distal from the surface of the substrate that is protected by a photoremovable protecting group. Any linker that may provide a reactive group protected by the photoremovable protecting group may be used. For example, the linker may be polyethyleneglycols, or nucleic acid monomers, such as nucleosides and nucleotides.

The term “protecting group” used herein refers to a group that is chemically bound to a monomer unit and may be removed by a selective exposure to an activator such electromagnetic radiation. The term “photoremovable protecting group” used herein refers to a protecting group that may be removed by light. Photoremovable protecting groups are well known to those of ordinary skill in the art. Examples of the photoremovable protecting group may include, but are not limited to, 6-nitroveratryloxycarbonyl (NVOC), 6-nitropiperonyl (NP), 6-nitropiperonyl oxycarbonyl (NPOC), 6-nitroveratryl (NV), methyl-6-nitroveratryl (MeNV), methyl-6-nitroveratryloxycarbonyl (MeNVOC), methyl-6-nitropiperonyl (MeNP), and methyl-6-nitropiperonyloxycarbonyl (MeNPOC).

As shown in Formula 1 below, the photoremovable protecting group may be attached to an activated nucleotide on the 5′-hydroxyl group:

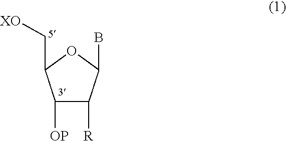

wherein B is a base bound to a sugar ring, R is a hydrogen atom when the sugar is deoxyribose, or R is a hydroxyl group when the sugar is ribose, P is an activated phosphoric acid group, and X is a photoremovable protecting group. The photoremovable protecting group X may be, as described above, NV, NP, MeNV, or MeNP. The activated phosphoric acid group P may be a reactive derivative with high coupling efficiency, such as phosphate triester, or phosphoramidite. Reaction conditions and other activated phosphoric acid groups are well known (see for example, U.S. Pat. Nos. 5,143,854, 5,744,305, and 5,908,926). In addition, a reactive group of the base is screened by a protecting group, and the screening and non-screening of the base are known in the art. The base may be uracil, adenine, guanine, thymine, cytosine, or inosine.

In addition, as shown in Formula 2 below, the photoremovable protecting group may be attached to an activated nucleotide on the 3′-hydroxyl group. The activated nucleotide in which the 3′-hydroxyl group is screened by the photoremovable protecting group may be a compound represented by Formula 2 below:

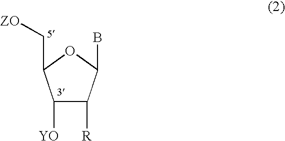

wherein B is a base in which an active group bound to a sugar ring is screened, R is a hydrogen atom when the sugar is deoxyribose, or R is a hydroxyl group when the sugar is ribose, Y includes a benzoinyl carbonate, such as dialkoxybenzoinyl carbonate, di(C₁-C₄)alkoxybenzoinyl carbonate, or 3′,5′ or 2′,3′-dimethoxybenzoinyl carbonate, and Z is phosphoramidite. The base may be uracil, adenine, guanine, thymine, cytosine, or inosine.

The linker may be selected from the group consisting of nucleosides and nucleotides, wherein a 3′-terminal of one of the nucleosides and nucleotides is attached to a substrate and a 5′-terminal of one of the nucleosides and nucleotides is attached to the photoremovable protecting group, or a 5′-terminal is attached to the substrate and a 3′-terminal is attached to the photoremovable protecting group. In addition, the nucleotides include polynucleotides that are synthesized in a previous process, or are foreign-introduced.

The formation of the pattern and the extension of the nucleic acid monomers may be repeatedly performed. In this case, a general washing process may be performed between the formation of the pattern and the extension of the nucleic acid monomers and between the extension of the nucleic acid monomers and the formation of the pattern. In addition, in the formation of the pattern, patterns that are the same as or different from each other may be formed according to the type of nucleotide to be introduced in each spot. In this process, one mask may be used for one nucleotide. Thus, when a 25 mer nucleic acid is synthesized, up to 100 masks may be used. Therefore, 100 cycles of mask preparation, light irradiation, detachment of the photoremovable protecting group, addition of the activated monomer having a photoremovable protecting group, and the coupling reaction are used.

The first single-stranded nucleic acid may be selected from the group consisting of DNA, RNA, PNA, and hybrid molecules thereof. When the first single-stranded nucleic acid is PNA, a dissociation constant of a hybridization product is low, and thus the double-stranded region is stable.

The length of the first single-stranded nucleic acid may be a length that may provide a binding force between the first single-stranded nucleic acid and a second single-stranded nucleic acid, obtained by hybridizing the first single-stranded nucleic acid with a first region of the second single-stranded nucleic acid. For example, the length may be about 4 nt to about 25 nt, about 5 nt to about 10 nt, or about 10 nt to about 25 nt.

The density of spots on which the first single-stranded nucleic acid extends may be 150,000 spots/cm² or greater. Light-directed synthesis methods of nucleic acids use a selective activation of a surface by using a patterned light, for example by using a photomask in the path of a light, and thus spots may be arranged with high density. However, a large amount of mask and many steps are used, and thus there is a limitation on a length to be synthesized.

The method of producing a microarray having an immobilized double-stranded nucleic acid probe including a double-stranded region and a single-stranded region further includes storing a sequence of the first single-stranded nucleic acid and a position on a substrate of a spot on which the sequence thereof is immobilized. The sequence of the first single-stranded nucleic acid is known, and the position on the substrate thereof is identified, and thus a position where the second single-stranded nucleic acid is hybridized may be confirmed. From this, a position of a double-stranded nucleic acid probe may be identified, and hybridization results obtained as a result of microarray analysis may be analyzed on each spot.

According to an embodiment of the invention, the operation (a) may further include: (a-1) selectively irradiating with light a first region of a spot region on a surface of a substrate and not irradiating with light a second region of the spot region on the surface, thereby forming a pattern of bright and dark regions, wherein the surface of the substrate has a photoremovable protecting group; (a-2) contacting the first region and the second region of the spot region of the surface of the substrate with a first nucleotide to link the first nucleotide to a polynucleotide of the first region and not to link the first nucleotide to the second region, wherein the first nucleotide has a photoremovable protecting group; (a-3) selectively irradiating with electromagnetic radiation at least one portion selected from the group consisting of at least one portion of the first region of the surface of the substrate and at least one portion of the second region of the surface of the substrate to remove the photoremovable protecting group therefrom; and (a-4) contacting the first region and the second region of the surface of the substrate with a second nucleotide to link the second nucleotide to a polynucleotide of the portion from which the photoremovable protecting group is removed.

According to an embodiment of the invention, the operation (a) may include: (a-1) attaching to a support a nucleoside including a photoremovable 3′ hydroxyl protecting group, wherein the attachment is via a 5′ hydroxyl of the nucleoside; (a-2) irradiating the obtained support-bound nucleoside so that the photoremovable protecting group is removed and the 3′ hydroxyl group is thereby freed; and (a-3) contacting the support-bound nucleoside with a nucleotide including a 5′ phosphoramidite to react the 5′ phosphoramidite with the free 3′ hydroxyl so that a dinucleotide is formed.

In addition, the method of producing a microarray having an immobilized double-stranded nucleic acid probe including a double-stranded region and a single-stranded region includes (b) hybridizing each of the first single-stranded nucleic acids with a second single-stranded nucleic acid including a first region complementary to the first single-stranded nucleic acid and a second region that is not complementary to the first single-stranded nucleic acid to convert the first single-stranded nucleic acid to a double-stranded nucleic acid probe including a double-stranded region and a single-stranded region. The second region is positioned upstream from the first region when a 5′ terminal of the first single-stranded nucleic acid is attached to the surface of the substrate, and the second region is positioned downstream from the first region when a 3′ terminal of the first single-stranded nucleic acid is attached to the surface of the substrate. The term “upstream” or “downstream” refers to relative position from a reference position in the nucleic acid. For example, when a sequence is positioned in the 5′ hydroxyl side from a reference position, the sequence is positioned in the upstream position and when a sequence is positioned in the 3′ hydroxyl side from a reference position, the sequence is positioned in the downstream position.

In operation (b), the hybridization may be performed under conditions that are known in the art, for example, in a buffer at 4° C. for 14 hours.

The first region of the second single-stranded nucleic acid is complementary to the first single-stranded nucleic acid, and thus the second single-stranded nucleic acid may be immobilized on the first single-stranded nucleic acid due to hybridization. The term “complementary” used herein means that 85% or greater, 90% or greater, 95% or greater, or 100% of sequences between nucleic acids are complementary to each other. In addition, the second region of the second single-stranded nucleic acid includes a sequence that is non-complementary to the first single-stranded nucleic acid. The term “non-complementary” used herein means that the second region is not substantially complementary to the first single-stranded nucleic acid, thus not interfering with hybridization between the first region and the first single-stranded nucleic acid. The second region may include a contiguous sequence of 5 nucleotides or less, 4 nucleotides or less, 3 nucleotides or less, or 2 nucleotides or less, which are complementary to the first single-stranded nucleic acid. The first region of the second single-stranded nucleic acid may be complementary to the first single-stranded nucleic acid with 100% identity and the second region of the second single-stranded nucleic acid may not contain a sequence that is complementary to the first single-stranded nucleic acid.

The second single-stranded nucleic acid may be synthesized in a medium that is different from a solid substrate in which the first single-stranded nucleic acid is synthesized or derived from natural nucleic acids. The synthesis of the second single-stranded nucleic acid in the different medium is well known in the art.

For example, synthesis of nucleic acids generally involves coupling an activated phosphoric acid derivative on a 3′ hydroxyl of a nucleotide with a 5′ hydroxyl of an oligomer bound to a solid substrate. The coupling reaction may be induced using two chemical methods: phosphate triester and phosphoramidite methods (Gait, “Oligonucleotide Synthesis”: A practical Approach”, 1984, IRL, Press, London).

The second single-stranded nucleic acid may be synthesized in a solid medium without using a photolithography process. In addition, the second single-stranded nucleic acid may be cDNA or be derived from a nucleic acid amplified by a nucleic acid amplification method, for example, PCR. Since the second single-stranded nucleic acid may not be synthesized in parallel at a plurality of positions, for example, through a mask, a relatively long nucleic acid may be synthesized with high efficiency. The second single-stranded nucleic acid may have a length of 50 nt or more, about 50 nt to about 3000 nt, or about 50 nt to about 1000 nt. In addition, the second single-stranded nucleic acid may be synthesized using a cell, or obtained by digesting natural nucleic acids with a restriction enzyme. The second region of the second single-stranded nucleic acid may have a length of 25 nt or more, about 25 nt to about 2975 nt, or about 25 nt to about 975 nt.

Operation (b) may further include setting the position of the double-stranded nucleic acid probe on the substrate to correspond to a position of the first single-stranded nucleic acid that is complementary to the first region of the second single-stranded nucleic acid, and storing the position of the double-stranded nucleic acid probe. The storing process may be performed in a computer readable medium. Thus, the position of the probe and/or hybridization results between a target nucleic acid and the probe may be confirmed and analyzed using a computer. That is, the sequence of the first single-stranded nucleic acid or the first region of the second single-stranded nucleic acid may be used as accessible information that may confirm the position of the probe or the analysis results of the hybridization.

One of the first single-stranded nucleic acids and the first region of the second single-stranded nucleic acid may be PNA, and the other thereof may be DNA or RNA. Hybridization intensity between PNA and DNA or RNA is relatively stronger than hybridization intensity between DNAs, RNAs, or DNA and RNA, and thus the second single-stranded nucleic acid may be stably immobilized on the first single-stranded nucleic acid.

The method of producing a microarray having an immobilized double-stranded nucleic acid probe including a double-stranded region and a single-stranded region may further include (c) reacting the double-stranded nucleic acid probe with a material that specifically binds to the double-stranded region of the double-stranded nucleic acid probe, thereby enhancing hybridization binding between the second single-stranded nucleic acid and the first single-stranded nucleic acid.

The material that specifically binds a double-stranded region of nucleic acid may be a double-strand specific-binding intercalator. The double-strand specific-binding intercalator may be SYBR Green I. The double-strand specific-binding intercalator better stabilizes a double bond, and thus decreasing a possibility of dissociating the single-stranded nucleic acids in the process of analyzing the double-stranded nucleic acid probe. In addition, the proximal terminal of the second single-stranded nucleic acid on the surface of the substrate may be immobilized on the first single-stranded nucleic acid or the substrate by a covalent bond or non-covalent bond.

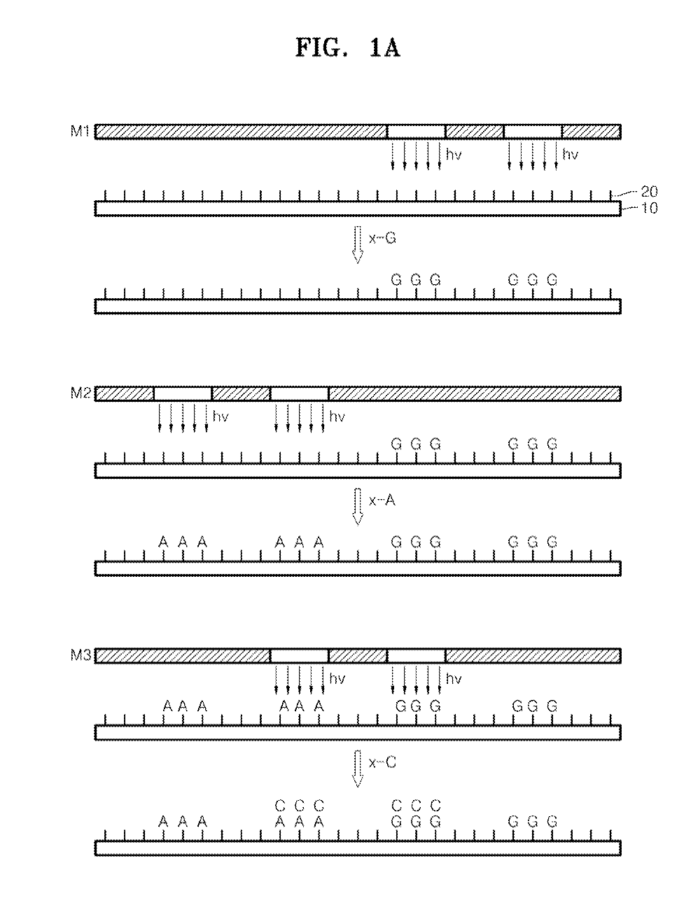

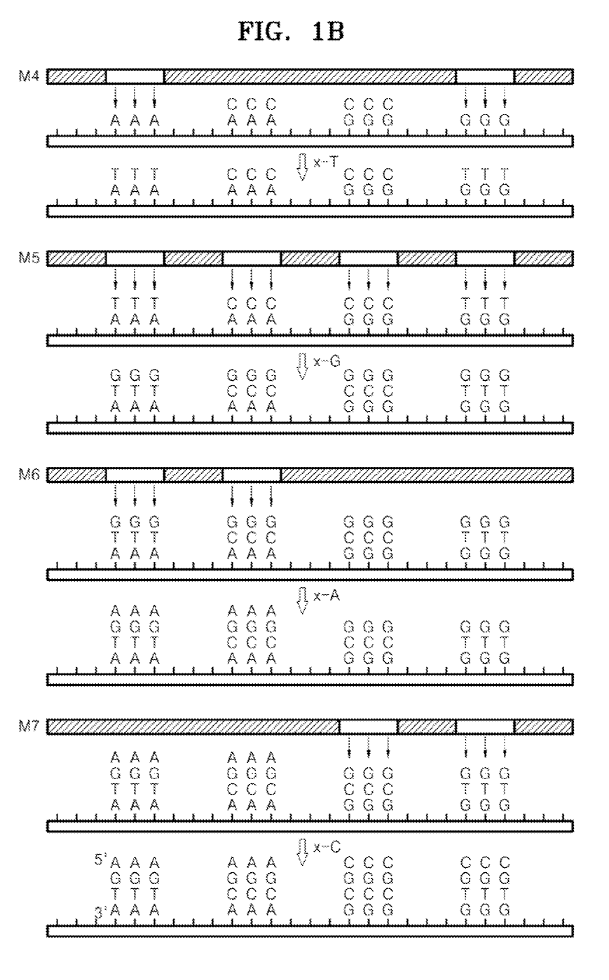

FIGS. 1A and 1B are diagrams illustrating a method of producing a single-stranded nucleic acid microarray having an immobilized double-stranded nucleic acid probe, according to embodiments of the invention. In FIGS. 1A and 1B, M1 through M7 denote masks, 10 denotes a substrate, and 20 denotes a photoremovable protecting group immobilized on a surface of the substrate 10. Referring to FIGS. 1A and 1B, in the masks M1 through M7, bright portions are regions through which light is transmitted, and hatched portions are regions through which light is not transmitted. The photoremovable protecting group 20 may be linked to a linker, a nucleic acid monomer, or an oligomer. In addition, the x in x-G, x-A, x-C, and x-T denotes a photoremovable protecting group where G, A, C, and T are the bases guanine, adenine, cytosine, and thymine, respectively. First, referring to FIG. 1A, when the substrate 10 is irradiated with light through the mask M1, the photoremovable protecting group 20 immobilized on the substrate 10 is removed from a predefined region that is irradiated by the light, and as a result, an active group is exposed. Then, the surface of the substrate 10 with the exposed active group is reacted with first activated nucleic acid monomers having a photoremovable protecting group to attach the first activated nucleic acid monomers to the surface of the substrate 10. Unreacted first activated nucleic acid monomers are removed by washing, and then predefined regions on the surface of the substrate 10 are irradiated with light through the mask M2, and the surface of the substrate 10 is reacted with second activated nucleic acid monomers having a photoremovable protecting group, thereby linking the second activated nucleic acid monomers to the first activated nucleic acid monomers. By repeatedly performing such processes using the masks M3 through M7, a single-stranded nucleic acid microarray on which four different single-stranded nucleic acid probes are respectively immobilized on four spot regions is prepared. In the first and second activated nucleic acid monomers having a photoremovable protecting group, the photoremovable protecting group may be, as shown in Formula 1 or 2 above, attached to the activated nucleotide on the 5′-hydroxyl or the 3′-hydroxyl. Referring to FIGS. 1A and 1B, the photoremovable protecting group is attached to the activated nucleotide on the 5′-hydroxyl. As shown in FIGS. 1A and 1B, when the light-directed synthesis of the single-stranded nucleic acids on a plurality of predefined regions is performed by activating the substrate 10 through the masks M1 through M7, an interval between the predefined regions may be narrowed. That is, the density of predetermined regions (spots) may be increased. However, the plurality of masks prepared in this case complicates the manufacturing processes.

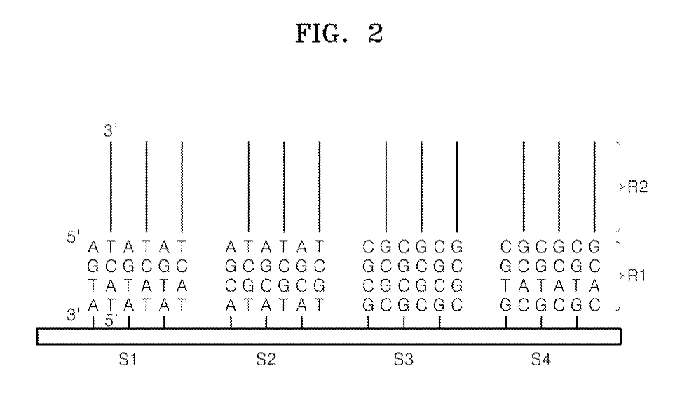

FIG. 2 is a diagram illustrating a method of converting the single-stranded microarray prepared in FIG. 1 to a double-stranded microarray, according to an embodiment of the invention. In FIG. 2, S1 through S4 denote spot regions on a substrate. Single-stranded nucleic acids of different sequences are respectively immobilized on the spot regions S1 through S4. In addition, in FIG. 2, R1 and R2 denote a double-stranded region and a single-stranded region of a double-stranded nucleic acid probe, respectively. Referring to FIG. 2, a first single-stranded nucleic acid of the double-stranded nucleic acid probe is synthesized on the substrate in the direction of 3′->5′, and thus a second single-stranded nucleic acid thereof including a complementary sequence to the first single-stranded nucleic acid is arranged in the direction of 5′->3′ from the substrate. However, an opposite case is also possible, in which the first single-stranded nucleic acid is synthesized on the substrate in the direction of 5′->3′, and the second single-stranded nucleic acid including a complementary sequence to the first single-stranded nucleic acid is arranged in the direction of 3′->5′ from the substrate. The second single-stranded nucleic acid may be obtained without using a mask by known solid-phase nucleic acid synthesis or by digesting natural nucleic acids with a restriction enzyme, and thus the second single-stranded nucleic acid may be relatively long. For example, the single-stranded region R2 may have a length of about 30 nt to about 1000 nt. In addition, although not illustrated in FIG. 2, the double-stranded region R1 may be treated with a material that specifically binds the double-stranded region R1 to enhance hybridization binding. For example, the material may be a double strand specific-binding intercalator compound, such as SYBR Green I. In addition, the proximal terminal of the second single-stranded nucleic acid on the substrate may be immobilized on the first single-stranded nucleic acid or the substrate by a covalent or non-covalent bond.

As described above, according to the above exemplary embodiments of the invention, by using a method of preparing a microarray on which a double-stranded nucleic acid probe including a double-stranded region and a terminal single-stranded region is immobilized, a microarray with high spot density and on which a long double-stranded nucleic acid probe is immobilized may be efficiently prepared.

It should be understood that the exemplary embodiments described herein should be considered in a descriptive sense only and not for purposes of limitation. Descriptions of features or aspects within each embodiment of the invention should typically be considered as available for other similar features or aspects in other embodiments of the invention.

What is claimed is:

1. A method of producing a microarray having an immobilized double-stranded nucleic acid probe comprising a double-stranded region and a single-stranded region, the method comprising:
synthesizing nucleic acids on a plurality of spot regions on a surface of a solid substrate using photolithography to immobilize a plurality of first single-stranded nucleic acids on the plurality of spot regions; and
hybridizing each of the plurality of first single-stranded nucleic acids with a second single-stranded nucleic acid comprising a first region complementary to the plurality of first single-stranded nucleic acids and a second region that is not complementary to the plurality of first single-stranded nucleic acids to convert the plurality of first single-stranded nucleic acids to double-stranded nucleic acid probes, each comprising a double-stranded region and a single-stranded region, wherein the second region is positioned upstream from the first region when a 5′ terminal of the first single-stranded nucleic acid is attached to the surface of the substrate, and the second region is positioned downstream from the first region when a 3′ terminal of the first single-stranded nucleic acid is attached to the surface of the substrate.

2. The method of claim 1, wherein the synthesizing of the nucleic acids comprises irradiating with light through a mask the surface of the substrate to which a photoremovable protecting group is attached to selectively remove the protecting group from the surface, thereby forming a pattern of reactive regions and light protected regions, and reacting the surface of the reactive regions with activated nucleic acid monomers having the photoremovable protecting group, thereby extending the nucleic acid monomers to the reactive regions on the substrate.

3. The method of claim 2, wherein the photoremovable protecting group attached to the substrate is attached to the substrate through a linker of which an active group at a distal terminal from the surface of the substrate is protected by the photoremovable protecting group.

4. The method of claim 2, wherein the linker is selected from the group consisting of a nucleoside and a nucleotide of which a 3′-terminal is attached to the substrate and a 5′-terminal is attached to the photoremovable protecting group, or of which a 5′-terminal is attached to the substrate and a 3′-terminal is attached to the photoremovable protecting group.

5. The method of claim 2, wherein the synthesizing and reacting are repeatedly performed.

6. The method of claim 2, wherein the nucleic acid monomers are nucleosides or nucleotides.

7. The method of claim 1, wherein the plurality of first single-stranded nucleic acids are selected from the group consisting of DNA, RNA, PNA, and hybrid molecules thereof.

8. The method of claim 1, wherein the plurality of first single-stranded nucleic acids each has a length of about 4 nt to about 25 nt.

9. The method of claim 1, wherein a density of the spot regions on which the plurality of first single-stranded nucleic acids are immobilized is greater than or equal to about 150,000 spots/cm².

10. The method of claim 1, further comprising storing sequences of the plurality of first single-stranded nucleic acids and a position on the substrate of spots on which the sequences are immobilized.

11. The method of claim 1, wherein, in the hybridizing of each of the plurality of first single-stranded nucleic acids, the second single-stranded nucleic acid is synthesized in a medium different from the solid substrate on which the plurality of first single-stranded nucleic acids are synthesized.

12. The method of claim 11, wherein the second single-stranded nucleic acid is synthesized in a solid medium without using photolithography.

13. The method of claim 11, wherein the second single-stranded nucleic acid comprises cDNA or DNA derived from a nucleic acid obtained by nucleic acid amplification.

14. The method of claim 11, wherein the second single-stranded nucleic acid has a length of 50 nt or greater.

15. The method of claim 14, wherein the second single-stranded nucleic acid has a length of about 50 nt to about 1000 nt.

16. The method of claim 1, wherein the hybridizing of each of the plurality of first single-stranded nucleic acids further comprises setting a position of the double-stranded nucleic acid probe on the substrate to correspond to a position of the plurality of first single-stranded nucleic acids that are complementary to the first region of the second single-stranded nucleic acid, and storing the position of the double-stranded nucleic acid probe.

17. The method of claim 1, wherein one of the plurality of first single-stranded nucleic acids and the first region of the second single-stranded nucleic acid is PNA, and the other thereof is DNA or RNA.

18. The method of claim 1, further comprising reacting the double-stranded nucleic acid probe with a material that specifically binds to a double-stranded region of nucleic acid, thereby enhancing hybridization binding between the second single-stranded nucleic acid and the plurality of first single-stranded nucleic acids.

19. The method of claim 18, wherein the material that specifically binds a double-stranded region of nucleic acid comprises a double-strand specific-binding intercalator.

20. The method of claim 19, wherein the intercalator comprises SYBR Green I.
